(19) United States
(12) Patent Application Publication
(10) Pub. No.: US 2025/0207639 A1
(43) Pub. Date: Jun. 26, 2025

(54) SLIP YOKE ASSEMBLY AND METHOD

(71) Applicant: Neapco Intellectual Property Holdings, LLC, Farmington Hills, MI (US)

(72) Inventors: Robert WEHNER, Livonia, MI (US); Erich HAGEN, Rochester Hills, MI (US); Victor SANCHEZ, Warren, MI (US)

(21) Appl. No.: 18/393,773

(22) Filed: Dec. 22, 2023

(51) Int. Cl. F16D 3/06; F16D 3/38; F16D 3/84

(52) U.S. Cl. CPC F16D 3/06; F16D 3/387; F16D 3/843

(57) ABSTRACT

A slip yoke assembly includes a cylindrical portion that extends along an axis and has a first end. An inner surface of the cylindrical portion defines a cavity along the axis. The inner surface defines a plurality of inner teeth that extend axially. The first end defines a counterbore about the cavity. The counterbore is defined by a first wall that extends at a transverse angle relative to the axis. A second wall extends substantially axially from the first wall. A plug is positioned in the counterbore and spans across the cavity in axial alignment with the second wall of the counterbore for engaging the second wall and providing primary sealing of the cavity. An annular lip seal is positioned in the counterbore against the first wall and is positioned axially between the first wall and the plug for providing supplementary sealing of the cavity.

### FIELD

The present disclosure generally relates to slip yoke assemblies, such as for propeller shafts for vehicles, and methods for making slip yoke assemblies.

### BACKGROUND

This section of the written disclosure provides background information related to slip yoke assemblies and associated methods and is not necessarily prior art to the inventive concepts disclosed and claimed in this application.

Propeller shaft assemblies for rear wheel drive (RWD) and four wheel drive (4WD) vehicles typically contain an internally splined slip yoke assembly for attachment to a transmission or transfer case output. Internal spline teeth on a cylindrical portion of the slip yoke are manufactured by passing one or more spline broach bars through a channel that passes through the cylindrical portion. This results in an open cavity that must be subsequently closed off to contain transmission or transfer case fluid that is pumped into the spline cavity to lubricate the spline and allow axial motion or telescoping through the spline during vehicle operation. The traditional approach of closing and sealing the cavity relies on a spherical shaped expanding steel welch plug placed into a counterbore, and held in place by a roll-formed lip. The counterbore is sealed without any type of sealant or elastomer, and is sealed only by interference pressure from expansion of the welch plug and the roll-formed retention lip. This traditional approach has been found to seal inadequately in some cases due to variations in manufacturing processes, which can lead to fluid leaking around the slip yoke welch plug.

Accordingly, there remains a need for improvements to slip yoke assemblies and associated methods.

### SUMMARY

This section provides a general summary of the inventive concepts associated with this disclosure and is not intended to be interpreted as a complete and comprehensive listing of all of its aspects, objectives, features and advantages.

According to an aspect of the disclosure, a slip yoke assembly includes a cylindrical portion that extends along an axis and has a first end. An inner surface of the cylindrical portion defines a cavity along the axis. The inner surface defines a plurality of inner teeth that extend axially. The first end defines a counterbore about the cavity. The counterbore is defined by a first wall that extends at a transverse angle relative to the axis. A second wall extends substantially axially from the first wall. A plug is positioned in the counterbore and spans across the cavity in axial alignment with the second wall of the counterbore for engaging the second wall and providing primary sealing of the cavity. An annular lip seal is positioned in the counterbore against the first wall and is positioned axially between the first wall and the plug for providing supplementary sealing of the cavity.

According to another aspect of the disclosure, a method for making a slip yoke assembly includes providing a cylindrical portion that extends along an axis and has a first end. An inner surface of the cylindrical portion defines a cavity along the axis. The inner surface defines a plurality of inner teeth that extend axially. The first end defines a counterbore about the cavity. The counterbore has a first wall that extends in a direction that is transverse to the axis and a second wall that extends from the first wall substantially axially. The method also includes positioning an annular lip seal and a plug into the counterbore, where the plug spans across the cavity and is positioned over the annular lip seal. The plug also has a top surface that extends upwardly in a convex shape. The method also includes pressing the top surface of the plug downwardly such that the plug presses the annular lip seal axially against the first wall of the counterbore and such that the plug presses radially against the second wall of the counterbore such that the lip seal and the plug seal the cavity.

The combination of the welch plug and lip seal provide a redundant and robust sealing mechanism for the cavity. Furthermore, both the welch plug and the lip seal are positioned in a single, simple and easy to machine counterbore.

### BRIEF DESCRIPTION OF DRAWINGS

The drawings described herein are for illustrative purposes only of selected embodiments and not all possible implementations and are not intended to limit the scope of the present disclosure.

FIG. 1 is a side, cross-sectional view of a slip yoke assembly, according to an aspect of the disclosure;

FIG. 2 is a side, cross-sectional view of an end of a cylindrical portion of the slip yoke assembly, illustrating an arrangement of a welch plug and a lip seal prior to compression of the welch plug;

FIG. 3 is a side, cross-sectional view of the end of the cylindrical portion of the slip yoke assembly, illustrating the arrangement of the welch plug and the lip seal during compression of the welch plug;

FIG. 4 is a side, cross-sectional view of the end of the cylindrical portion of the slip yoke assembly, illustrating the arrangement of the welch plug and the lip seal after compression of the welch plug;

FIG. 5 is a side, cross-sectional view of the welch plug and the lip seal;

FIG. 6, is a cross-sectional, perspective view of the welch plug and the lip seal;

FIG. 7 is a magnified cross-sectional view of a side of the welch plug and the lip seal; and

FIG. 8 is a flow diagram illustrating a method of making a slip yoke assembly according to an aspect of the disclosure.

### DETAILED DESCRIPTION

Referring to the figures, wherein like numerals indicate corresponding parts throughout the several views, a slip yoke assembly 10 is generally shown. The subject slip yoke assembly 10 may be used on the drivelines of various vehicles such as automobiles, off-road vehicles, and recreational vehicles.

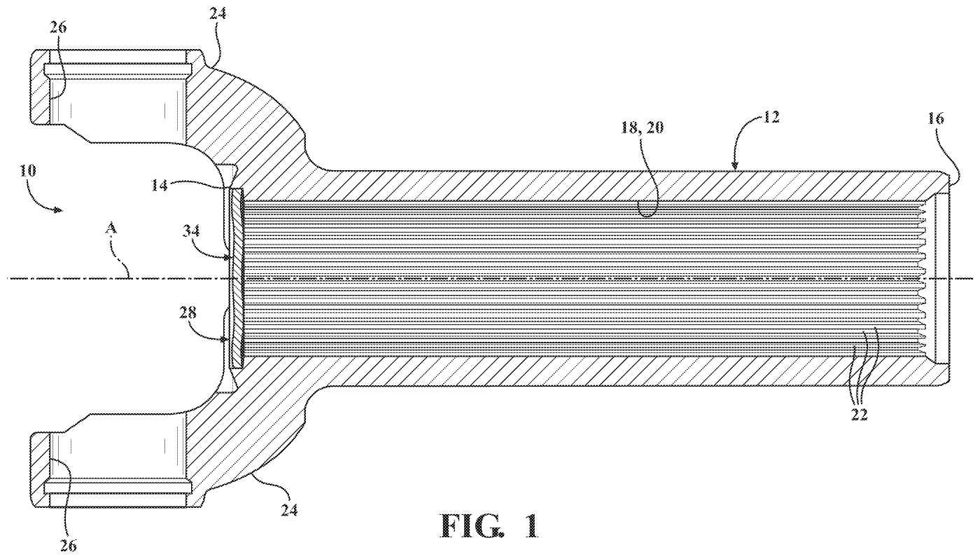

As shown in FIG. 1, the slip yoke assembly 10 includes a cylindrical portion 12 that extends along an axis A between a first end 14 and a second end 16. The cylindrical portion 12 has an inner surface 18 that defines a cavity 20 which extends axially between the first and second ends 14, 16. The inner surface 18 defines a plurality of inner teeth 22 that extend axially and are positioned in circumferentially spaced relationship with one another. The teeth 22 are configured to be interleaved with outer teeth of another shaft (not shown) which is received in the cavity 20 in order to provide relative axial movement between the cylindrical portion 12 and the shaft while transmitting rotational movement between the cylindrical portion 12 and the shaft. For example, the other shaft may be a transfer case output shaft which holds transmission fluid.

A pair of lug ears 24 extend from the first end 14 of the cylindrical portion 12 on circumferentially opposite sides of the cylindrical portion 12. Each of the lug ears 24 has an arc-shape, and the lug ears 24 together generally have a U-shape. Each of the lug ears 24 defines a bore 26 that extends therethrough perpendicularly to the axis A for being connected to a spider of a universal joint. The bores 26 of the two lug ears 24 are positioned in alignment with one another.

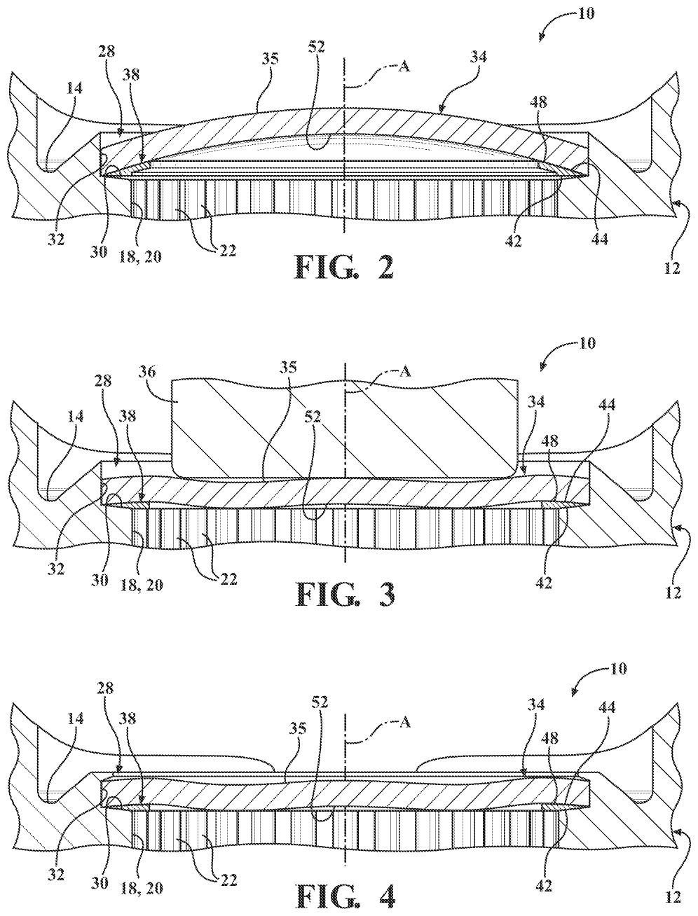

As shown in FIGS. 2-4, the first end 24 of the cylindrical portion 12 defines a counterbore 28 which extends axially into the cylindrical portion 12 and is located about the cavity 20 of the cylindrical portion 12 between the lug ears 24. The counterbore 28 has a first wall 30 that extends in cross-section at a slightly obtuse angle relative to the axis A, and a second wall 32 that extends from the first wall 30 generally axially. The slightly obtuse angle of the first wall 30 relative to the axis A ensures that contact between the first wall 30 and the welch plug 34 occurs primarily at an outer edge of the welch plug 34 after the welch plug 34 is flattened and expanded, where an edge seal can be formed by high contact pressure. However, varying angles between 90° and 100° may be used. Accordingly, the first and second walls 30, 32 together define a single, simple to machine counterbore 28.

As will be discussed in further detail, the subject assembly 10 includes an annular lip seal 38 of an elastic material and a welch plug 34 of a steel material that are together received in the counterbore 28 and compressed against the walls 30, 32 of the counterbore 28 to create a redundant seal for the cavity 20 of the cylindrical portion 12.

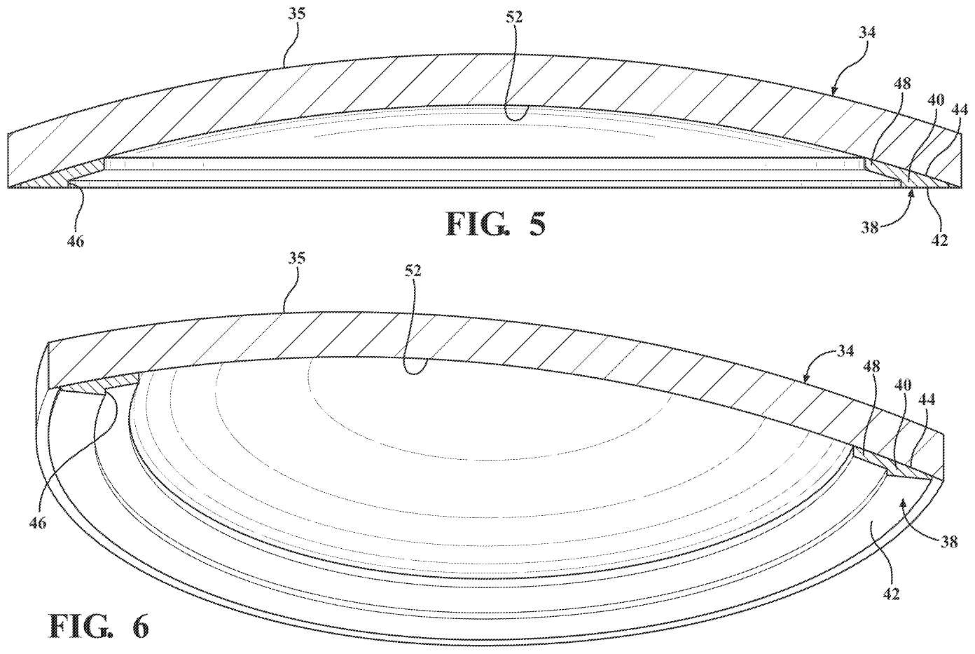

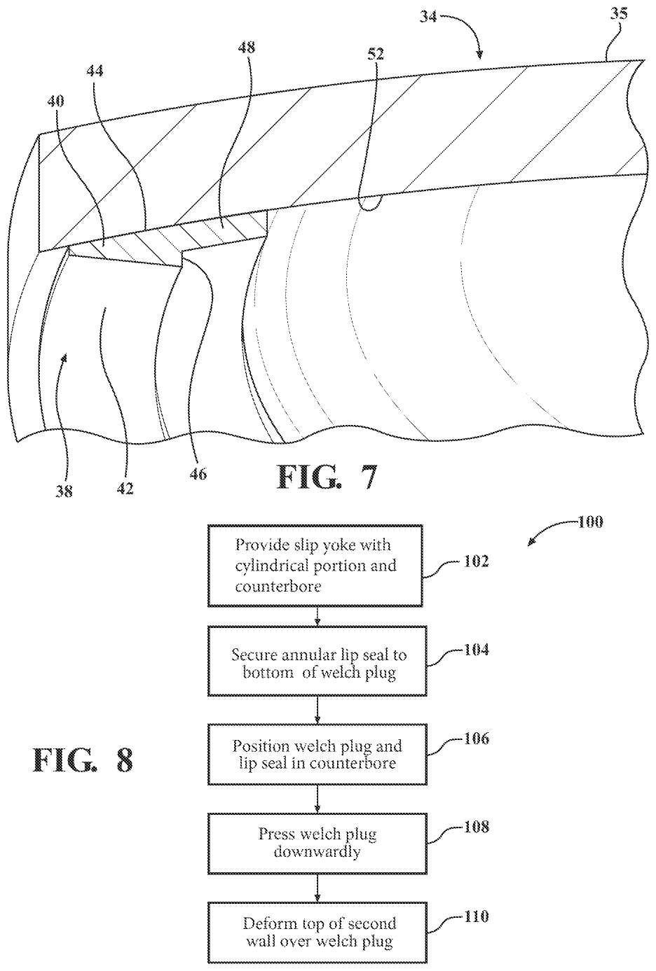

More particularly, the annular lip seal 38 is connected to a bottom surface 52 of the welch plug 34 and positioned in the counterbore 28 axially between the first wall 30 of the counterbore 28 and the welch plug 34. According to the preferred embodiment, the lip seal 38 is made of an injection molded and bonded elastomeric material, but could be made of other suitable materials and via other methods without departing from the scope of the present disclosure. As best shown in FIGS. 5-7, the lip seal 38 has a first portion 40 that generally has a triangular shaped cross-section. The first portion 40 has a bottom 42 that extends perpendicularly to the axis A over the first wall 30 of the counterbore 28, and a top 44 that extends in curved upward fashion relative to the bottom 42 in an uncompressed state to match the profile of the bottom surface 52 of the welch plug 34 as shown in FIGS. 2 and 5-7. The first portion 40 has a side wall 46 on a radially inward side of the annular lip seal 38 (toward the axis A). The annular lip seal 38 also has a second portion 48 that extends from the top 44 of the first portion 40 toward the axis in similar curved upward fashion relative to the bottom 42 of the first portion 40 in the uncompressed state such that a step is defined between the side wall 46 and a bottom surface 50 of the second portion 48. As best shown in FIGS. 2-4, the second portion 48 radially overlies the cavity 20 of the cylindrical portion 12 while the first portion 40 is radially offset from the cavity 20. The annular lip seal 38 is positioned entirely axially beneath the welch plug 34. The overall shape of the lip seal 38 with first and second portions 40, 48 provides the benefit of keeping the lip seal 38 concentrated over the counterbore 28 rather than being over the splined region of the cavity 20.

The welch plug 34 is of a stiff material such as steel. The welch plug 34 is positioned in the counterbore 28 and spans across the cavity 20. FIGS. 2 and 5-7 show the welch plug 34 in an initial, pre-flattened state, while FIGS. 3-4 show the plug 34 after a flattening operation. Prior to flattening, the welch plug 34 generally has a disc shape with a top surface 35 that has a convexly protruding center, and after flattening the top surface 35 is generally planar but may have some variation in flatness as illustrated in FIGS. 1, 3 and 4. As shown, in FIG. 3, the welch plug 34 is flattened via a downward force applied at the center of the top surface 35 via a cylindrical flattening tool 36 or other suitable flattening mechanism. The flattening force causes the first portion 40 of the lip seal 38 to be compressed against the first wall 30 of the counterbore 28 to seal the lip seal 38 to the first wall 30, and causes an outer diameter of the welch plug 34 to move radially outwardly such that is pressed against the second wall 32 of the counterbore 28 to seal the welch plug to the cylindrical portion 12. As shown in FIGS. 3-4, once compressed, the lip seal 38 extends substantially in a horizontal shape perpendicular to the axis A.

The lip seal 38 is molded substantially flush with a bottom 52 of the welch plug 34, and bonded to the bottom 52 via a bonding agent. According to the preferred embodiment, the lip seal 38 is bonded to the bottom 52 of the welch plug 34 during an injection molding process which is used to make the lip seal 38. Bonding the lip seal 38 to the bottom 52 in this manner prior to assembling the slip yoke assembly 10 advantageously protects the lip seal 38. More particularly, because the lip seal is positioned beneath the welch plug 34 even prior to compressing the welch plug 34 downwardly, there is a reduced opportunity for damage to the lip seal 34. This is contrary to conventional slip yoke assemblies which typically include a protruding lip seal or a separate o-ring seal, each of which are prone to being damaged before assembly. Furthermore, the presence of the second portion 48 of the of the lip seal 38 provides an expanded bonding surface to the welch plug 34 to improve robustness. Furthermore, the approximately 45 degree angle of the tops of the first and second portions 40, 48 of the lip seal 38 permits the lip seal 38 to fit snuggly against the bottom 52 of the welch plug 54.

With reference to FIG. 8, a method for making a slip yoke assembly 10 is also provided. The method includes 102 providing a cylindrical portion 12 with a counterbore 28 as described above. The method also includes 104 securing an annular lip seal 38 to a bottom surface 52 of a welch plug 34. The method also includes 106 positioning the annular lip seal 38 and the welch plug 34 in the counterbore 28. At this point, the welch plug 34 has a convexly shaped top surface 35 and spans across the cavity 20. Also, the annular lip seal 38 is positioned axially between the welch plug 34 and first wall 30 of the counterbore 28. Initially, the welch plug 34 is loosely fitted (clearance fit) and at this point the lip seal 38 is unpressurized. The method continues with 108 pressing the welch plug 34 downwardly against the annular lip seal 38 such that the welch plug 34 deforms radially outwardly and engages the second wall 32 of the counterbore 28 to seal the welch plug 34 against the second wall 32. At this point, the lip seal 38 is also axially pressed against the first wall 30 of the counterbore 28 to provide a supplementary seal. The method further includes 110 deforming a top of the second wall 32 of the counterbore 28 over a top of the welch plug 34 to further secure the welch plug 34 in place to permanently secure the welch plug 34 and further enhance the seal. According to the preferred embodiment, this step is performed using a rotary forming machine.

In view of the above, the slip yoke assembly 10 uses two distinct sealing mechanisms—the welch plug 34 and lip seal 28—for redundancy and robustness. Specifically, it uses the metal-to-metal seal from the expansion of the welch plug 34 against the second wall 32 of the counterbore 28, and the roll-formed segment of the second wall 32 over the welch plug 34, while providing added robustness from the compressed lip seal 38. Additionally, the slip yoke assembly 10 uses a simple and easy to machine geometry of the counterbore 28. It does not require new machined counterbores or other features to provide controlled compression of the lip seal 38 as is common with conventional slip yoke assemblies. Rather, the process of flattening the welch plug 34 provides a controlled compression of the lip seal 38.

Additionally, the slip yoke assembly 10 is fully compatible with traditional slip yoke assembly processes, in that the shape of the welch plug shape 34 requires no changes to part feeding systems, and traditional plug flattening and roll forming processes can be utilized.

Obviously, many modifications and variations of the present invention are possible in light of the above teachings and may be practiced otherwise than as specifically described while within the scope of the appended claims. Individual elements or features of a particular embodiment are generally not limited to that particular embodiment, but, where applicable, are interchangeable and can be used in a selected embodiment, even if not specifically shown or described.

What is claimed is:

1. A slip yoke assembly, comprising:
a cylindrical portion extending along an axis and having a first end and an inner surface defining a cavity along the axis;
the inner surface defining a plurality of inner teeth extending axially;
the first end defining a counterbore about the cavity, the counterbore defined by a first wall extending at a transverse angle relative to the axis, and a second wall extending substantially axially from the first wall;
a plug positioned in the counterbore and spanning across the cavity in axial alignment with the second wall of the counterbore for engaging the second wall and providing primary sealing of the cavity; and
an annular lip seal positioned in the counterbore positioned axially between the first wall and the plug for providing supplementary sealing of the cavity.

2. The slip yoke assembly as set forth in claim 1, wherein the welch plug is compressed against and sealingly engages the second wall of the counterbore.

3. The slip yoke assembly as set forth in claim 1, wherein the first wall of the counterbore extends at an obtuse angle up to 100 degrees relative to the axis.

4. The slip yoke assembly as set forth in claim 1, wherein the welch plug has a top surface that extends upwardly in a convex shape and has a bottom surface with a concave shape, and wherein an annular lip seal has a first portion having a bottom extending substantially perpendicularly to the axis over the first wall of the counterbore and a top extending at an angle relative to the bottom such that the first portion generally has a triangular shape, and wherein the first portion has a side wall on a radially inward side of the annular lip seal.

5. The slip yoke assembly as set forth in claim 4, wherein the top of the annular lip seal extends in a contacting relationship with the bottom surface of the welch plug.

6. The slip yoke assembly as set forth in claim 5, wherein the annular lip seal further includes a second portion projecting from the top of the first portion toward the axis in a contacting relationship with the bottom surface of the welch plug such that a step is defined between the side wall and a bottom surface of the second portion.

7. The slip yoke as set forth in claim 6, wherein the second portion radially overlies the cavity of the cylindrical portion.

8. The slip yoke as set forth in claim 6, wherein the first portion of the lip seal engages the first wall of the counterbore and the second portion of the lip seal overlies the cavity of the cylindrical portion.

9. The slip yoke as set forth in claim 1, wherein the lip seal is positioned entirely axially beneath the plug.

10. The slip yoke as set forth in claim 1, wherein the lip seal is bonded to a bottom of the plug.

11. The slip yoke as set forth in claim 10, wherein substantially an entirety of a top surface of the lip seal is bonded to the bottom of the plug.

12. A method for making a slip yoke assembly, comprising:
providing a cylindrical portion extending along an axis and having a first end and an inner surface defining a cavity along the axis, wherein the inner surface defines a plurality of inner teeth extending axially, and wherein the first end defines a counterbore about the cavity, wherein the counterbore has a first wall extending in a direction that is transverse to the axis and a second wall extending from the first wall substantially axially;
positioning an annular lip seal and a plug in the counterbore, with the plug positioned over the annular lip seal and with the plug spanning across the cavity, wherein the plug has a top surface that extends upwardly in a convex shape and a bottom surface having a concave shape; and
pressing the top surface of the plug downwardly such that the plug presses the annular lip seal axially against the first wall of the counterbore and such that the plug presses radially against the second wall of the counterbore such that the lip seal and plug seal the cavity.

13. The method as set forth in claim 12 further including deforming a top of the second wall of the counterbore over a top of the plug to further secure the plug in place.

14. The method as set forth in claim 12 further including bonding the lip seal to a bottom of the plug prior to the step of positioning the annular lip seal and plug in the counterbore.

15. The slip yoke as set forth in claim 14, wherein substantially an entirety of a top surface of the lip seal is bonded to the bottom of the plug.

16. The method as set forth in claim 12, wherein the annular lip seal has a first portion that has a bottom that extends in a direction that is transverse to the axis and a top that extends in contact with the bottom surface of the plug, wherein the first portion has a side wall on a radially inward side of the annular lip seal, and wherein the annular lip seal further includes a second portion projecting from the top of the first portion toward the axis in contacting relationship with the bottom surface of the welch plug such that a step is defined between the side wall and a bottom surface of the second portion.

17. The method as set forth in claim 16, wherein after pressing of the top surface of the plug, the first portion of the lip seal engages the first wall of the counterbore and the second portion of the lip seal overlies the cavity of the cylindrical portion.
